(19) United States
(12) Patent Application Publication
(10) Pub. No.: US 2017/0004853 A1
(43) Pub. Date: Jan. 5, 2017

(54) IMPLEMENTING ENHANCED IN-SITU MONITORING OF HEAD OVERCOAT WEAR FOR CONTROLLED BURNISHING AND EARLY DETECTION OF HEAD FAILURE IN HDD

(71) Applicant: HGST Netherlands B.V., Amsterdam (NL)

(72) Inventors: Sripathi Vangipuram Canchi, Sunnyvale, CA (US); Charles Mathew Mate, San Jose, CA (US); Sukumar Rajauria, San Jose, CA (US); Erhard Schreck, San Jose, CA (US)

(21) Appl. No.: 14/790,697

(22) Filed: Jul. 2, 2015

(51) Int. Cl. G11B 5/455

(52) U.S. Cl. CPC G11B 5/455

(57) ABSTRACT

A method, apparatus, and system are provided for implementing in-situ monitoring of head overcoat burnishing and early detection of head failure in a hard disk drive (HDD). A voltage is applied across a slider-disk interface between the slider body and the disk. Realtime monitoring of electrical current flowing across the slider-disk interface is performed for determining an amount of burnishing of the slider.

### FIELD OF THE INVENTION

The present invention relates generally to the data storage field, and more particularly, relates to a method, apparatus, and system for implementing in-situ monitoring of head overcoat burnishing and early warning detection of impending head failure in a hard disk drive (HDD).

### DESCRIPTION OF THE RELATED ART

Many data processing applications require long-term data storage and typically a high-degree of data integrity. Typically these needs are met by non-volatile data storage devices. Non-volatile storage or persistent media can be provided by a variety of devices, most commonly, by direct access storage devices (DASDs), which also are referred to as hard disk drives (HDDs).

During normal disk drive operations, the head flies at very low clearances, for example <1 nm, or in TFC induced contact with the disk. This can lead to the head overcoat being worn off, exposing the read and write elements to damage

Two long standing long standing problems in hard disk drive technology, that are often in conflict, are first reducing contributions of the recording head roughness and recording head overcoat for reduction of head media spacing (HMS) and second ensuring the long term wear and corrosion protection of head read-write elements.

One technique proposed to reduce contributions of the recording head roughness and recording head overcoat to head media spacing (HMS) is to burnish the recording head surface in the region around the read sensor and the write pole in a controlled manner. It is desirable to do this in-situ after the drive has been manufactured to adjust these contributions to HMS in order to achieve the optimum recording performance for each head-disk interface. It is also desirable to stop this burnishing process in a controlled manner to avoid damage to the read sensor and write pole.

Also a need exists to effectively detect an impending failure of a read-write head in the field.

### SUMMARY OF THE INVENTION

Aspects of the preferred embodiments are to provide a method, apparatus, and system for implementing in-situ monitoring of head overcoat burnishing and early warning detection of impending head failure in a hard disk drive (HDD). Other important aspects of the preferred embodiments are to provide such method, apparatus, and system substantially without negative effect and to overcome some of the disadvantages of prior art arrangements.

In brief, a method, apparatus, and system are provided for implementing in-situ monitoring of head overcoat burnishing and early warning detection of impending head failure in a hard disk drive (HDD). A voltage is applied across a slider-disk interface between the slider body and the disk. Realtime monitoring of electrical current flowing across the slider-disk interface is performed for determining an amount of burnishing of the slider.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representation illustrating a system for implementing in-situ monitoring of head overcoat burnishing and early warning detection of impending head failure in a hard disk drive (HDD) in accordance with preferred embodiments;

FIG. 2 schematically illustrates an example circuit for implementing in-situ monitoring of head overcoat burnishing and early warning detection of impending head failure in a hard disk drive (HDD) in accordance with preferred embodiments;

FIG. 3 schematically illustrates a cross-sectional view of the slider-disk interface within an example apparatus for implementing in-situ monitoring of head overcoat burnishing and early warning detection of impending head failure in a hard disk drive (HDD) in accordance with preferred embodiments;

FIGS. 4, 5, and 6 are flow charts illustrating example operations for implementing in-situ monitoring of head overcoat burnishing and early warning detection of impending head failure in a hard disk drive (HDD) in accordance with preferred embodiments; and

FIG. 7 is a block diagram illustrating a computer program product in accordance with preferred embodiments.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the preferred embodiments, a method, apparatus, and system for implementing in-situ monitoring of head overcoat burnishing and early warning detection of impending head failure in a hard disk drive (HDD).

In accordance with features of the preferred embodiments, monitoring the degree of wear is achieved by measuring the current that flows between the slider and disk either at the applied voltage used during the burnish process or by periodically changing the voltage to one or more monitoring voltages.

In accordance with features of the preferred embodiments, during a reduction of HMS mode, when the measured values of current values reach threshold conditions, the burnishing process is modified, for example the burnishing process is slowed down or stopped either by changing the applied voltage or reducing the amount of thermal protrusion of the head. During a reliability check mode, if the measured current values reach certain threshold conditions, a warning signal for reliability check is given to the hard disk controller in order to take appropriate corrective actions.

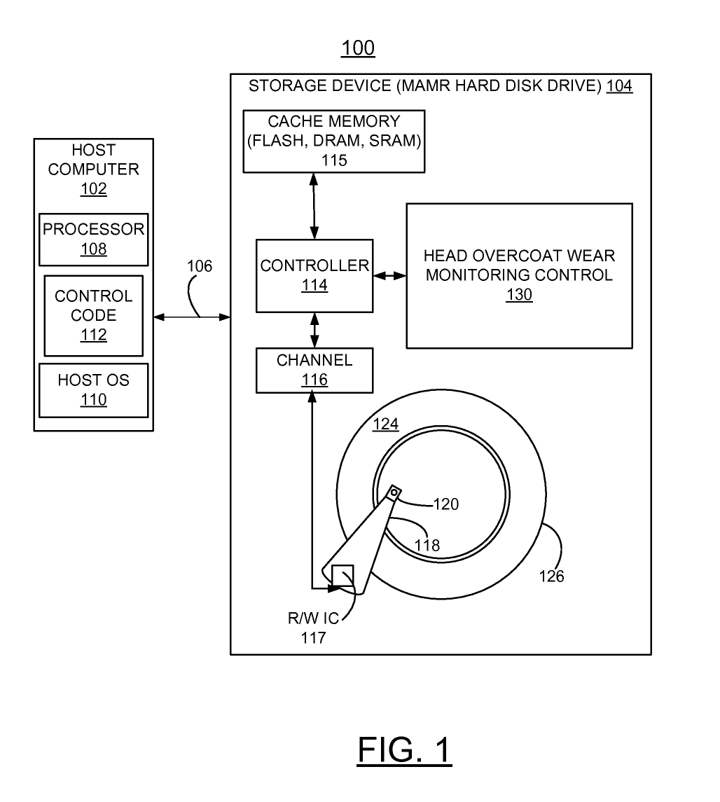

Having reference now to the drawings, in FIG. 1, there is shown an example system generally designated by the reference character 100 for implementing in-situ monitoring of head overcoat burnishing and early warning detection of impending head failure for various hard disk drives (HDDs) in accordance with preferred embodiments. System 100 includes a host computer 102, a storage device 104, such as a hard disk drive (HDD) 104, and an interface 106 between the host computer 102 and the storage device 104.

As shown in FIG. 1, host computer 102 includes a processor 108, a host operating system 110, and control code 112. The storage device or hard disk drive 104 includes a controller 114 coupled to a cache memory 115, for example, implemented with one or a combination of a flash memory, a dynamic random access memory (DRAM) and a static random access memory (SRAM), and coupled to a data channel 116. The storage device or hard disk drive 104 includes a Read/Write (R/W) integrated circuit (IC) 117 implementing in-situ monitoring of head overcoat burnishing and early warning detection of impending head failure of the preferred embodiments. The storage device or hard disk drive 104 includes an arm 118 carrying a slider 120 for in accordance with preferred embodiments. The slider 120 flies over a writable disk surface 124 of a disk 126.

In accordance with features of preferred embodiments, a head overcoat wear monitoring control 130 is provided with the controller 114, for example, for implementing in-situ monitoring of head overcoat burnishing and early warning detection of impending head failure in a hard disk drive (HDD).

System 100 including the host computer 102 and the HDD 104 is shown in simplified form sufficient for understanding the present embodiments. The illustrated host computer 102 together with the storage device or HDD 104 is not intended to imply architectural or functional limitations. The present invention can be used with various hardware implementations and systems and various other internal hardware devices.

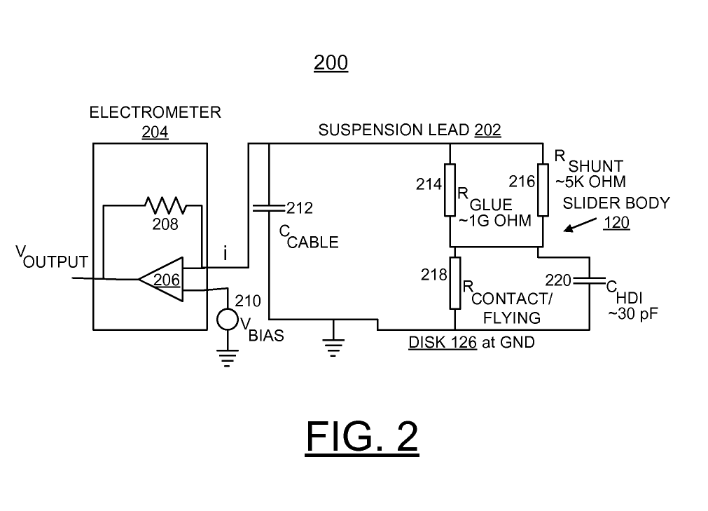

Referring now FIG. 2, there is shown example apparatus generally designated by the reference character 200 for implementing in-situ monitoring of head overcoat burnishing and early warning detection of impending head failure in a hard disk drive (HDD) of the preferred embodiments.

As shown in FIG. 2, apparatus 200 includes a suspension lead 202 coupled to a slider body 120 and a disk 126 at ground GND potential. Apparatus 200 includes an electometer 204 including an operational amplifier 206 with a feedback resistor 208 coupled between a first input receiving a current i connected to the suspension lead 202 and a voltage output V_{OUTPUT}. Operational amplifier 206 includes a second input connected to a voltage source 210 V_{BIAS}. Apparatus 200 includes a cable capacitance 212 between the suspension lead 202 and the disk 126 at ground GND potential. Apparatus 200 includes parallel connected resistors 214, 216. The resistor 214 represents a glue resistor, for example of 1G ohm, and resistor 216 represents a shunt resistor, for example of 5K ohm. A parallel connected contact/flying resistor 218 and head disk interface capacitance 220 is provided between the parallel connected resistors 214, 216 and the disk 126 at ground GND potential.

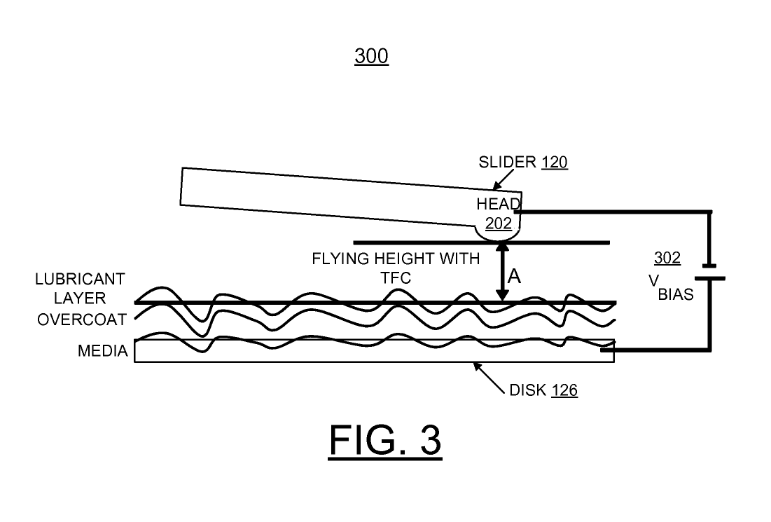

Referring now to FIG. 3, there is shown example apparatus generally designated by the reference character 300 for implementing in-situ monitoring of head overcoat burnishing and early warning detection of impending head failure in a hard disk drive (HDD) in accordance with preferred embodiments. Apparatus 300 implements in-situ monitoring of head overcoat burnishing using a voltage 302 V_{BIAS} applied across the slider-disk interface between the slider body 120 and the disk 126. Typically, a more negative voltage reduces head wear and a more positive voltage promotes head wear. A flying height with a thermal flyheight control (TFC), not shown, is indicated by an arrow A.

In accordance with features of the preferred embodiments, realtime monitoring of interfacial current i flowing across head-disk interface is performed. Real-time monitoring of interfacial current i flowing across head-disk interface takes advantage of the current i being inversely proportional to electrical resistance 218, R_{contact/flying} of the head-disk interface. The magnitude of the interfacial current lil or |Vₒᵤₜₚᵤₜ|) increases as head overcoat becomes thinner through wear.

In accordance with features of the preferred embodiments, when |Vₒᵤₜₚᵤₜ| exceeds a threshold value, corrective measures are taken, for example either to reduce or terminate further head wear, to warn the customer of impending head failure, or to safeguard data from impending head failure.

In accordance with features of the preferred embodiments, burnishing with a DC monitoring voltage is provided. The same or different amount of TFC overpush is used during the current measurement period as during the burnish period. When the value of the current (Vₒᵤₜₚᵤₜ) goes above a predetermined threshold value, the burnish process is either terminated or the burnish rate is reduced until a second threshold value is reach, at which point the burnishing process is terminated.

In accordance with features of the preferred embodiments, burnishing with an AC monitoring voltage is provided. The V_{bias} is oscillated at a frequency f and the component of Vₒᵤₜₚᵤₜ at this frequency is measured using locking detection to determine R(V_{bias})=di/dV_{bias}. When the value of R(V_{bias}) passes a predetermined threshold, the burnish process is either slowed or terminated.

In accordance with features of the preferred embodiments, burnishing at a different voltage is provided. One voltage V_{burn} is applied to head to achieve the best burnish rate and another voltage V_{bias} is applied periodically to the head for a short period of time to measure the current at this monitor voltage. The monitor voltage is chosen at a voltage that provides low wear and good signal to noise for the current measurement. This measurement can be done in either the DC or AC mode.

In accordance with features of the preferred embodiments, burnishing with multiple monitoring voltages is provided. One voltage V_{burn} is applied to head to achieve the best burnish rate and multiple voltages are applied periodically to the head for short periods of time to measure the current at these monitor voltages V_{bias-1}, V_{bias-2}, and the like. These measurements at multiple voltages are used to determine the non-linear behavior of R(V_{bias}).

In accordance with features of the preferred embodiments, early warning detection of possible head failure is provided. During these reliability checks, the head can be either overpushed into contact or kept at a small clearance. One or more monitoring voltages are applied between the slider and the disk. If the current, measured in AC or DC mode, is too high, this indicates a potential head failure in the near future and the drive controller can takes corrective actions.

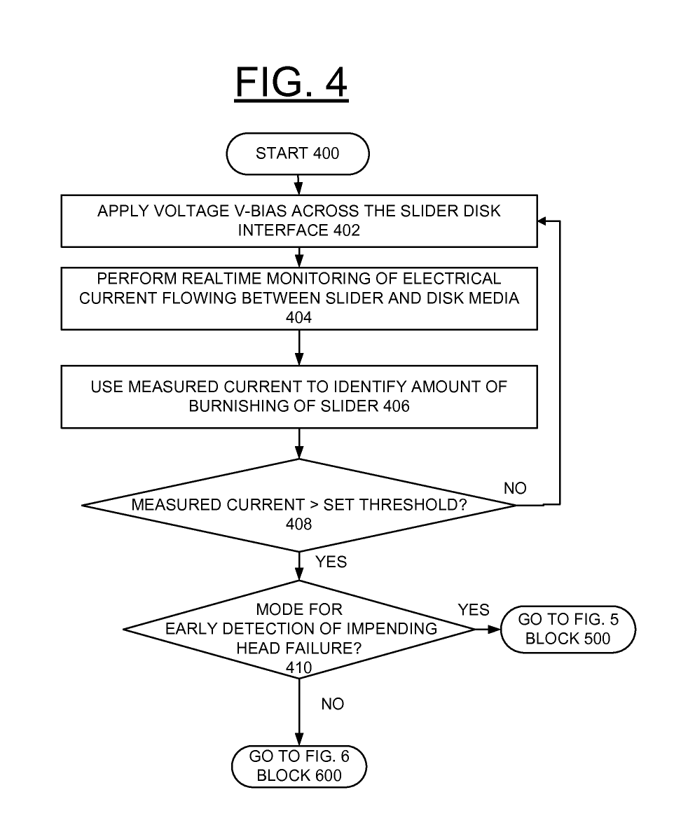

FIGS. 4, 5, and 6 are flow charts illustrating example operations for implementing in-situ monitoring of head overcoat burnishing and early warning detection of impending head failure in a hard disk drive (HDD) in accordance with preferred embodiments.

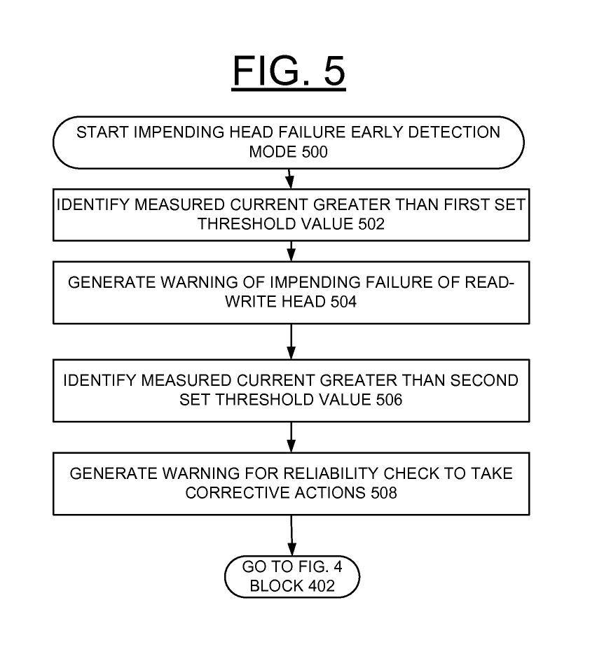

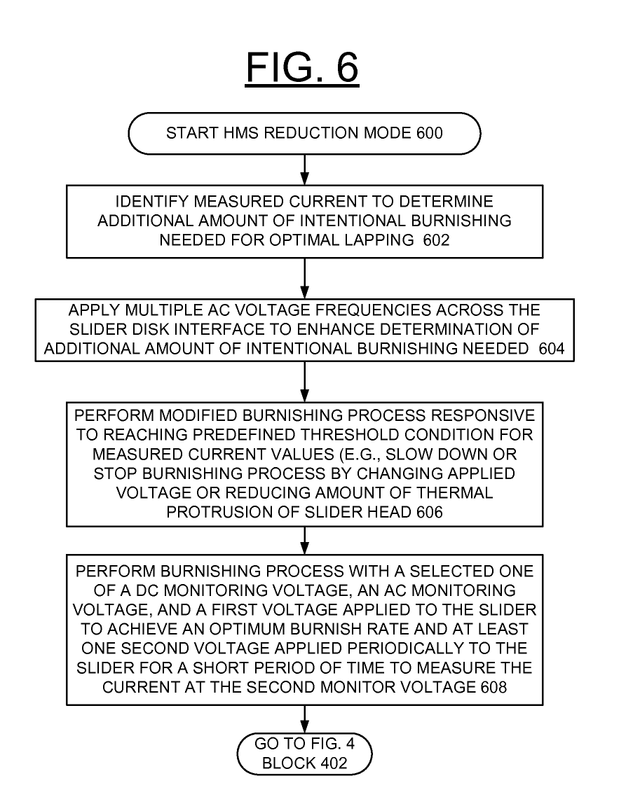

Referring now to FIG. 4, example operations for implementing in-situ monitoring of head overcoat burnishing and early warning detection of impending head failure start as indicated in a block 400. A voltage 302, V_{BIAS} is applied across the slider-disk interface between the slider body 120 and the disk 126 as indicated in a block 402. Realtime monitoring of electrical current flowing between the slider and disk media is performed as indicated in a block 404. The measured current is used to identify an amount of burnishing of the slider as indicated in a block 406. As indicated in a decision block 408, the measured current is compared with a set threshold. When the measured current is less than the set threshold, operations return to block 402 to continue monitoring. When the measured current reaches the set threshold, as indicated in a decision block 410, checking if in the monitoring mode for early detection of impending head failure is performed. When in the monitoring mode for early detection of impending head failure, operations continue to FIG. 5 at block 500. Otherwise, when monitoring head overcoat wear for burnishing, operations continue to FIG. 6 at block 600.

Referring now FIG. 5, impending head failure early detection mode starts as indicated in a block 500. As indicated in a block 502, checking to identify measured current greater than a first set threshold value. When the identified measured current is greater than the first set threshold value, a warning is generated of impending failure of the read-write head as indicated in a block 504. As indicated in a block 506, checking to identify measured current greater than a second set threshold value. When the identified measured current is greater than the second set threshold value, a warning is generated for a reliability check to take corrective actions as indicated in a block 508. Operations return to block 402 in FIG. 4 and continue.

Referring now FIG. 6, monitoring mode for head overcoat wear for burnishing starts as indicated in a block 600. As indicated in a block 602, measured current is identified to determine additional amount of intentional burnishing needed for optimal lapping. As indicated in a block 604 multiple AC voltage frequencies are applied across the slider disk interface to enhance determination of additional amount of intentional burnishing needed. As indicated in a block 606, a modified burnishing process is performed responsive to reaching predefined threshold condition for measured current values, for example, to slow down or stop burnishing process by changing applied voltage or reducing amount of thermal protrusion of slider heat. As indicated in a block 608, burnishing process is performed with a selected one of a DC monitoring voltage, an AC monitoring voltage, and a first voltage applied to the slider to achieve an optimum burnish rate and at least one second voltage applied periodically to the slider for a short period of time to measure the current at the second monitor voltage. Operations return to block 402 in FIG. 4 and continue.

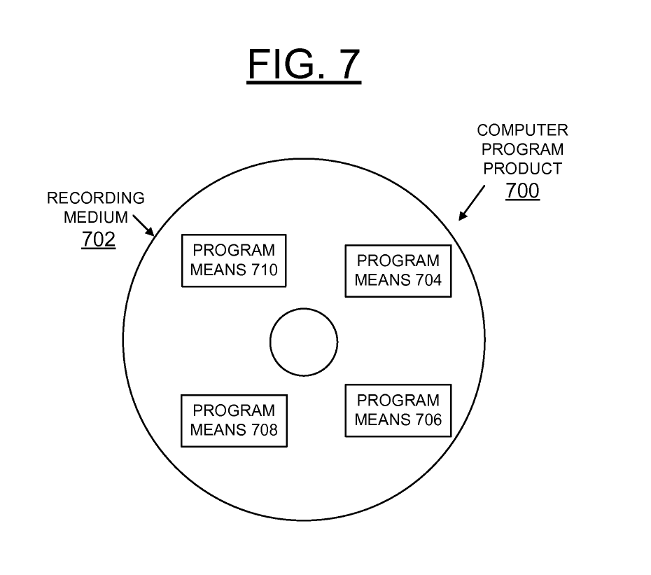

Referring now to FIG. 7, an article of manufacture or a computer program product 700 of the preferred embodiments is illustrated. The computer program product 700 includes a computer readable recording medium 702, such as, a floppy disk, a high capacity read only memory in the form of an optically read compact disk or CD-ROM, a tape, or another similar computer program product. Computer readable recording medium 702 stores program means or control code 704, 706, 708, 710 on the medium 702 for carrying out the methods for implementing in-situ monitoring of head overcoat burnishing and early detection of impending head failure for hard disk drives in accordance with preferred embodiments in the system 100 of FIG. 1.

A sequence of program instructions or a logical assembly of one or more interrelated modules defined by the recorded program means or control code 704, 706, 708, 710, direct HDD controller 114 for implementing in-situ monitoring of head overcoat burnishing and early detection of impending head failure during HDD operation of preferred embodiments.

While the present invention has been described with reference to the details of the embodiments of the invention shown in the drawing, these details are not intended to limit the scope of the invention as claimed in the appended claims.

1. A method for implementing in-situ monitoring of head overcoat burnishing for a hard disk drive (HDD), said method comprising:
applying a voltage across a slider-disk interface between a slider body and a disk, and
responsive to the applied voltage across a slider-disk interface, performing realtime monitoring of electrical current flowing across the slider-disk interface, and determining an amount of burnishing of the slider.

2. The method as recited in claim 1, includes implementing head failure detection of a read-write head by comparing the monitored electrical current with at least one threshold value.

3. The method as recited in claim 1, includes using the monitored electrical current to determine a needed amount of intentional burnishing.

4. The method as recited in claim 1, wherein applying a voltage across the slider-disk interface between the slider body and the disk includes applying one or more AC voltage frequencies across the slider-disk interface between the slider body and the disk to determine an amount of intentional burnishing.

5. The method as recited in claim 1, wherein applying a voltage across the slider-disk interface between the slider body and the disk includes identifying a threshold value of the monitored electrical current and providing a predefined warning signal.

6. The method as recited in claim 1, wherein applying a voltage across a slider-disk interface between a slider body and a disk includes identifying a predefined threshold value of the monitored electrical current and modifying a burnishing process.

7. The method as recited in claim 6, includes performing burnishing with a selected one of a DC monitoring voltage, an AC monitoring voltage, and a first voltage applied to the slider to achieve an optimum burnish rate and at least one second voltage applied periodically to the slider for a short period of time to measure the current at the second monitor voltage.

8. An apparatus for implementing in-situ monitoring of head overcoat burnishing for a hard disk drive (HDD), comprising:
a controller;
at least one disk; said disk including a disk media for storing data;
a slider;
said controller applying a voltage across a slider-disk interface between a slider body and a disk, and
said controller, responsive to the applied voltage across a slider-disk interface, performing realtime monitoring of electrical current flowing across the slider and disk media, and determining an amount of burnishing of the slider.

9. The apparatus as recited in claim 8 includes control code stored on a non-transitory computer readable medium, and wherein said controller uses said control code to implement in-situ monitoring of electrical current flowing across the slider and disk media, and determining an amount of burnishing of the slider.

10. The apparatus as recited in claim 8 includes said controller implementing impending head failure detection by comparing the monitored electrical current with at least one threshold value.

11. The apparatus as recited in claim 8 includes said controller using the monitored electrical current to determine an amount of intentional burnishing needed.

12. The apparatus as recited in claim 8 includes said controller applying one or more AC voltage frequencies across the slider-disk interface between the slider body and the disk to determine an amount of intentional burnishing needed.

13. The apparatus as recited in claim 8 includes said controller identifying a threshold value of the monitored electrical current and providing a predefined warning signal.

14. The apparatus as recited in claim 8 includes said controller identifying a predefined threshold value of the monitored electrical current and modifying a burnishing process.

15. The apparatus as recited in claim 8 includes said controller performing burnishing with a selected one of a DC monitoring voltage, an AC monitoring voltage, and a first voltage applied to the slider to achieve an optimum burnish rate and at least one second voltage applied periodically to the slider for a short period of time to measure the current at the second monitor voltage.

16. A system for implementing in-situ monitoring of head overcoat burnishing for a hard disk drive (HDD), comprising:
a hard disk drive (HDD), said HDD comprising a controller;
at least one disk; said disk including a disk media for storing data;
a slider;
said controller applying a voltage across a slider-disk interface between a slider body and a disk, and
said controller, responsive to the applied voltage across a slider-disk interface, performing realtime monitoring of electrical current flowing across the slider and disk media, and determining an amount of burnishing of the slider.

17. The system as recited in claim 16 includes control code stored on a non-transitory computer readable medium, and wherein said controller uses said control code to implement of electrical current flowing across the slider and disk media, and determining an amount of burnishing of the slider.

18. The system as recited in claim 16 includes said controller implementing impending head failure detection by comparing the monitored electrical current with at least one threshold value, said controller identifying a predefined threshold value of the monitored electrical current and providing a predefined warning signal.

19. The system as recited in claim 16 includes said controller applying one or more AC voltage frequencies across the slider-disk interface between the slider body and the disk to determine an amount of intentional burnishing needed.

20. The system as recited in claim 16 said controller identifying a predefined threshold value of the monitored electrical current and modifying a burnishing process.
